(19) United States
(12) Patent Application Publication
(10) Pub. No.: US 2013/0071517 A1
(43) Pub. Date: Mar. 21, 2013

(54) COLLECTIBLE ITEM INCLUDING EDIBLE CONFECTIONARY IMAGE ITEM AND NOVELTY IMAGE ITEM

(71) Applicant: Halle MADIA, Princeton Junction, NJ (US)

(72) Inventor: Halle MADIA, Princeton Junction, NJ (US)

(21) Appl. No.: 13/623,643

(22) Filed: Sep. 20, 2012

Related U.S. Application Data
(60) Provisional application No. 61/536,605, filed on Sep. 20, 2011.

(51) Int. Cl. A23G 3/50; A23G 4/18

(52) U.S. Cl. 426/5; 426/104; 426/383

(57) ABSTRACT

A collectible item comprising a novelty image item and an edible confectionary image item is provided. The novelty image item may contain an image that matches the image on the confectionary image item, or an image that is related to the image on the confectionary image item. A plurality of collectible image items may be provided on a sheet, and the collectible image items may be individually removable from the sheet. An intermediate layer may also be provided which separates the confectionary image item from the novelty image item. The collectible item may include stickers as the novelty image item, and may include gum with an image formed thereon as the confectionary image item.

### RELATED APPLICATIONS

This application claims priority to U.S. Provisional Application No. 61/536,605, filed on Sep. 20, 2011, which is incorporated herein in its entirety.

### FIELD AND BACKGROUND OF THE INVENTION

This application relates to confectionary image items and novelty image items and more particularly, to a product comprising a confectionary layer with an image formed thereon combined with a sticker or other novelty item.

### SUMMARY OF THE INVENTION

One aspect of the present invention is a collectible item formed of a novelty item and edible confectionary item assembly, comprising a novelty image item, an intermediate layer, and an edible confectionary image item. The novelty image item may comprise multiple novelty image items on a card or sheet having a smooth top surface, with the novelty image items being spaced from one another on the top surface. Alternatively, a collectible item may be formed of a single novelty image item and confectionary image item. Each novelty image item may have an image on a top surface, with the image facing up relative to the card/sheet. The confectionary image item may have a top surface and a bottom surface, with the top surface having embedded thereon an edible image. The bottom surface of the confectionary image item may be adjacent to the intermediate layer, such that the intermediate layer separates the novelty image item from the confectionary image item. The intermediate layer may form a backing for the layer of confectionary image item. The intermediate layer may also be adheringly attached to the top surface of the novelty image item or a perimeter of the top surface of the novelty image item.

According to various embodiments of the invention, the novelty image items may be, but are not limited to, stickers, temporary tattoos, collectible trading cards, band-aids, business cards, greeting cards, stationary, or invitations. Other novelty items which include an image may also be used as the novelty image item. Additionally, the novelty image items included with a confectionary image item may include a combination of novelty image items, such as a combination of stickers, temporary tattoos, trading cards, and the like.

According to some embodiments, the image on the novelty image item may match the edible image on the confectionary image item. According to other embodiments, the images on the novelty image item and confectionary image item may be different.

Although the following description is given with reference to the confectionary image item being gum, it is noted that the confectionary image item may be formed of other edible confectionary products, such as, but not limited to, lollipop, gummy candy, a hard candy, fruit roll, and the like. As such, in the embodiments described below, the present invention contemplates the gum item being substituted with another edible confectionary item including an image.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings.

FIG. 1 is a sectional view of a sheet of collectible items including a novelty image item and confectionary image item, in accordance with one embodiment of the present invention.

FIG. 2 is a sectional view of a collectible item, in accordance with one embodiment of the present invention.

FIG. 2A is a sectional view of a collectible item in which the confectionary to image item is smaller than the novelty image item, in accordance with one embodiment of the present invention.

FIG. 3 is a top view of novelty image items, shown as stickers, on a sheet after gum and gum backing layers have been removed, in accordance with one embodiment of the present invention.

FIG. 4 is a top view of a sheet showing collectible items with the confectionary image item, shown as chewable gum, still intact in accordance with one embodiment of the present invention.

### DETAILED DESCRIPTION OF THE INVENTION

The present invention generally provides a collectible item comprising a novelty image item and a confectionary image item, such as a chewable gum layer, in which after the confectionary image item is taken and consumed, there still remains a novelty image item that can be traded, collected, and/or stored individually or collectively on sheets that may be bound together in a book form. The confectionary image item, which may comprise a layer of gum with an image disposed thereon, may have an edible image matching the image on the novelty image item. An intermediate layer between the confectionary image item and novelty image item may be included, wherein the intermediate layer separates the novelty image item from the confectionary image item. The intermediate layer may also contain a message whose content may relate to the image on the novelty image item, such as a cartoon or sport character.

The novelty image item of the present invention may be combined with a confectionary image item, such as chewable gum. In some embodiments, the image on the novelty image item may match an edible image on the confectionary image to item. In other embodiments, the image on the novelty image item may be different than the image on the confectionary image item. Some embodiments of the present invention combine a plurality of novelty image items on a sheet with confectionary image items, such as chewable gum, that may include an edible image on the confectionary item itself or on edible icing paper forming a top portion of the confectionary item. The image on the confectionary image item may be embedded or printed directly thereon, or may be printed on high resolution photo paper, rice, gum paste, or icing papers and then affixed to the confectionary image item with an edible adhesive.

Some embodiments of the present invention include a single novelty image item or a sheet of novelty images items, paired with confectionary image items, such as chewable gum. Some embodiments of the present invention may also include an intermediate layer, such as backing paper, wax paper, or plastic wrapping. The intermediate layer may contain another image, such as a secret message that may be relevant to the novelty image item or confectionary image item. According to other embodiments, the secret message may be contained in the image on the novelty image item itself.

The collectible items of the present invention may be collectible on sheets of more than one or as individual collectible items. The novelty image items may be separately collectible after the confectionary image item has been removed. In some embodiments, the collectible items may be suitable for a ring of a binder. By attaching the novelty image items to a layer that has perforations, the novelty image items may be collectible individually or as a set of items. Alternatively, the confectionary image layer and attached novelty image item may be presented as an individual item, as opposed to being presented on a sheet comprising multiple items. In this case, each individual novelty image item combined with a confectionary image item may be part of a set of collectible items. In some embodiments where the collectible items are formed as part of a sheet, the sheet may be a full single sheet. In other embodiments where perforations are used, the sheet may contain a plurality of different novelty image items and confectionary image item combinations which can be separated from one another by tearing along the perforations.

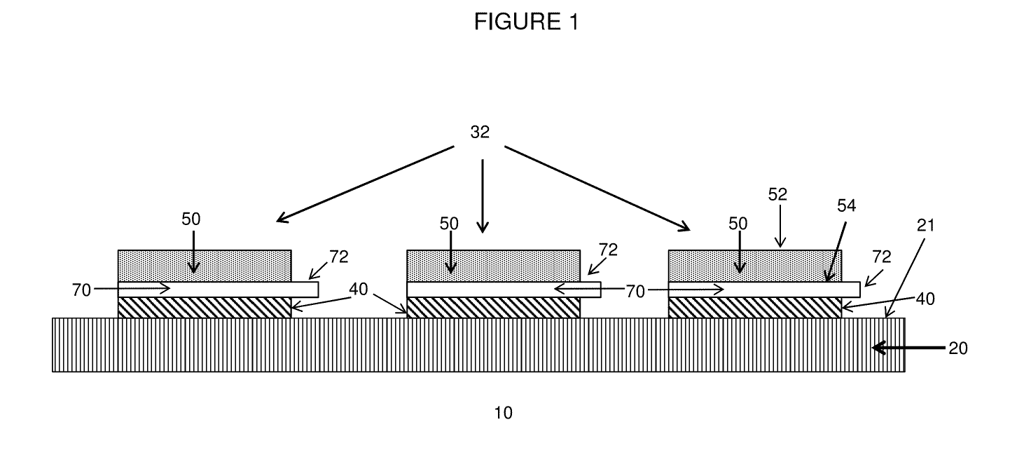

According to various embodiments of the invention, the novelty image items may include, but are not limited to, stickers, temporary tattoos, collectible trading cards, band-aids, business cards, greeting cards, stationary, or invitations. As discussed above, the confectionary image item may be gum, lollipop, hard candy, gummy candy, fruit roll or other confectionary product with an image formed thereon. The images on the confectionary image item may be directly printed thereon, embedded therein, and/or included on another edible layer placed on top of the confectionary item. For purposes of illustration with respect to FIGS. 1-4, the novelty image item is discussed in terms of a sticker and the confectionary image item is discussed in terms of edible gum. However, it is noted that the stickers or gum may be replaced with any other type of novelty image item or confectionary product with images formed thereon, including those described above. The stickers may be of various types, including scented, scratch-and-sniff, foil, reflective, or hologram stickers.

As shown in FIG. 1, an assembly 10 of collectible items may include at least one novelty image item 40, shown as a sticker, and at least one confectionary image item 50, shown as gum. The assembly may include a sheet 20 having a top surface 21. Sheet 20 may be a blister pack with cavities, or may have a surface 21 which is substantially smooth other than the protrusions from any novelty image items. The sheet 20 may be formed of a pliable material such as paper or thin plastic or may be made of a more rigid material such as cardboard. The novelty image items and confectionary image items may be affixed to the top surface of the sheet, or may be removably placed on top of the sheet. As shown in FIG. 1, each collectible item 32 may include chewable gum 50 as the confectionary image item that may have a top surface 52 and a bottom surface 54. The chewable gum 50 may be situated above the sticker 40 as shown, or may be provided below the sticker. In some instances, the chewable gum is separated from the sticker by an intermediate layer 70 positioned between the gum 50 and the sticker 40. The intermediate layer may be backing paper, plastic wrapping, wax paper, adhesive paper, or other material designed to separate the sticker from the gum.

Alternatively, the chewable gum may be in contact with the back of the sticker paper, facing outward. In this alternative embodiment, the intermediate layer may not be necessary and the gum may directly contact the back of the sticker paper.

The gum 50 may have embedded thereon an edible image that may match an image on the sticker image 40. The term “match” as used in this case can mean matching the entirety of the image or it can mean matching a particular portion of the image such as the face of the character or the tail of the character or a particular feature of the character that is on the sticker 40. Typically, edible image may appear on a top surface 52 of gum 50 although edible image may appear at any visible surface including a side surface of gum 50. The bottom surface 54 of the gum 50 may be adhered the intermediate layer 70, made of thin backing paper that sticks to the gum. The edible image may be part of the gum itself or in some preferred embodiments may be an edible paper such an edible photo, rice or icing paper. The edible image may also be placed on high resolution paper, such as high resolution photo, rice, gum paste, or icing paper and then affixed to the gum with an edible adhesive.

In some preferred embodiments, the intermediate layer 70 may have a tab 72 to make it easy to remove the intermediate layer from the gum, and to remove the gum from the sticker or its perimeter. Intermediate layer 70 may also be able to adhere to the sticker 40, for example by adhering to the image on the top surface of sticker 40.

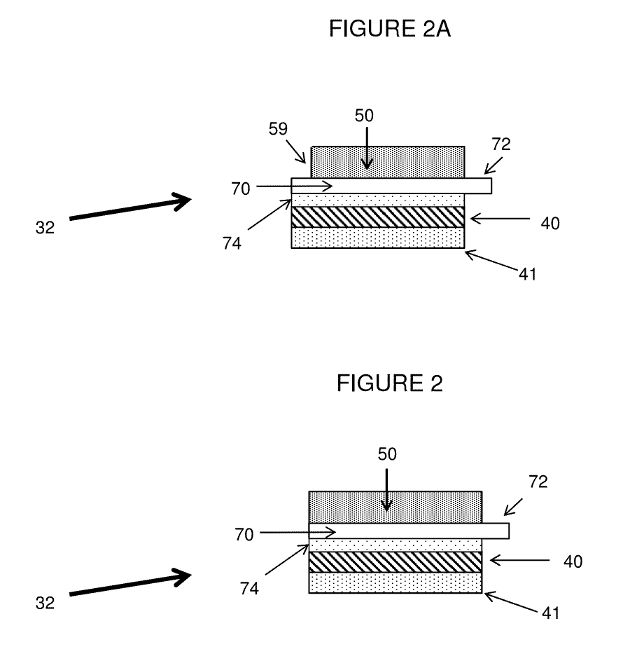

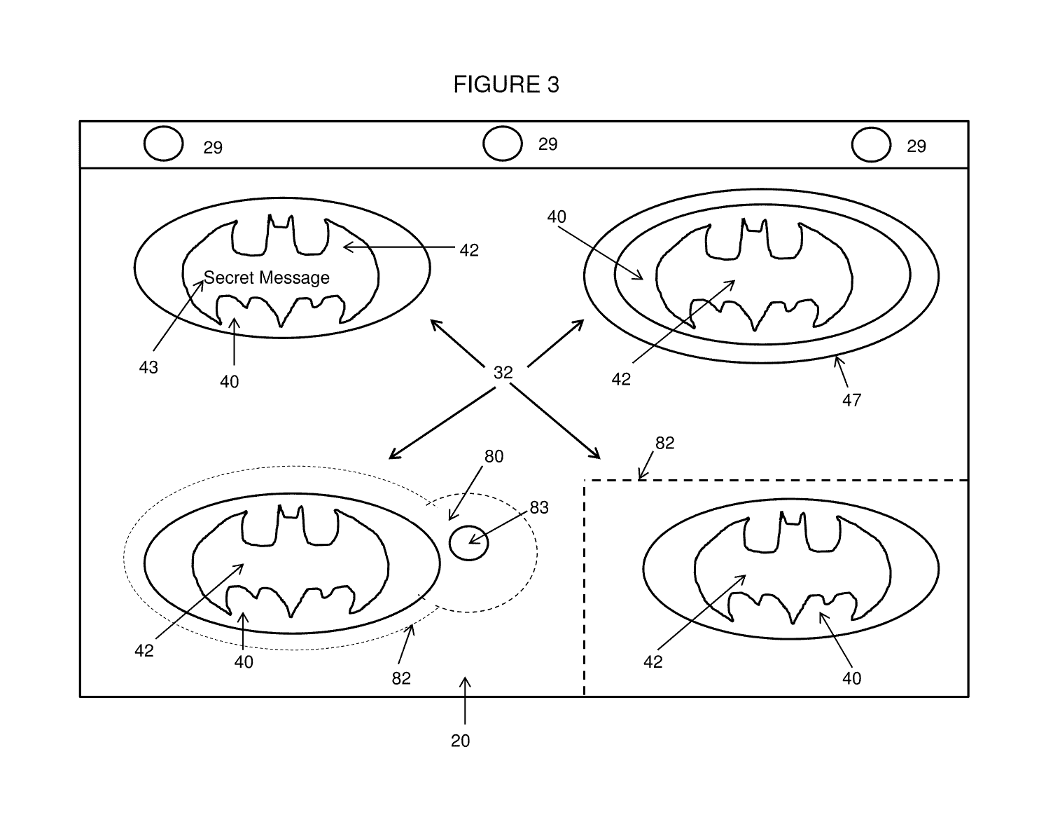

As shown in FIGS. 2 and 2A, adhering of the intermediate layer to the sticker 40 may be done by means of an adhering means 74, such as an adhesive applied to the bottom surface of intermediate layer 70. The adhesive 74 may be such that it will not ruin the sticker image. In other preferred embodiments, intermediate layer 70 may be able to adheringly attach to the sticker 40 or to an area around the sticker. For example, intermediate layer 70 may adhere to the top surface of sticker 40 or to a perimeter of the top surface of the sticker. The perimeter of the top surface of the sticker may be the perimeter of the top surface of the sticker itself, or, as shown in FIG. 3, may be the perimeter 47 surrounding the top surface of the sticker which actually forms part of the sheet 20. As shown in FIG. 2, sticker 40 may also have a peelable back layer 41 whose removal allows the sticker to be adheringly affixed to the sheet, as shown in FIG. 1, as well as to any other place that one may wish to place stickers.

According to some embodiments, intermediate layer 70 shown in FIGS. 2 and 2A may have a secret message incorporated thereon, for example printed on it. The message may be a preprinted message that may be revealed only upon removable of the intermediate layer 70 from the gum 50. In some preferred embodiments, the content of the message relates to the character whose image appears on the sticker and whose matching image appears on top of the gum. In some other preferred embodiments, the message relates to other things of interest to the consumer, and not necessarily to the character whose image appears on the sticker of that precise collectible item 32.

In an alternative embodiment, the secret message may be printed on the surface of the novelty image item, which would be hidden by the edible chewing gum layer. FIG. 3 illustrates a sheet of collectible items 32 after the gum and any intermediate layers have been removed, leaving the novelty image items 40, shown as stickers, visible to the consumer. As shown on FIG. 3, the message 43 may be included on the image 42 of a sticker 40. The image of the novelty image item may still mostly match the edible image of the chewing gum, with the only differences being the addition of the message overlaying the other images of the novelty image item. Alternatively, the image of the novelty image item may be different from the image of the chewing gum layer, with the novelty image item being the secret message itself or having the secret message as well as another image.

Referring back to FIG. 2, gum layer 50 may be approximately or exactly the size of the sticker 40, and tab 72 of intermediate layer 70 may be used to separate the layers. Without peeling off the gum 50 from the sticker 40, a consumer would at least see the tab 72 of intermediate layer 70. In other embodiments, such as shown in FIG. 2A, it is possible for one to see at least some portions of the actual sticker 40 beneath the gum 50 while collectible item 32 is on sheet 20. As shown in FIG. 2A, gum 50 may be slightly smaller than the sticker 40, and/or gum 50 may have a cut-out corner or section without material 59 allowing a portion of the sticker 40 below to be visible.

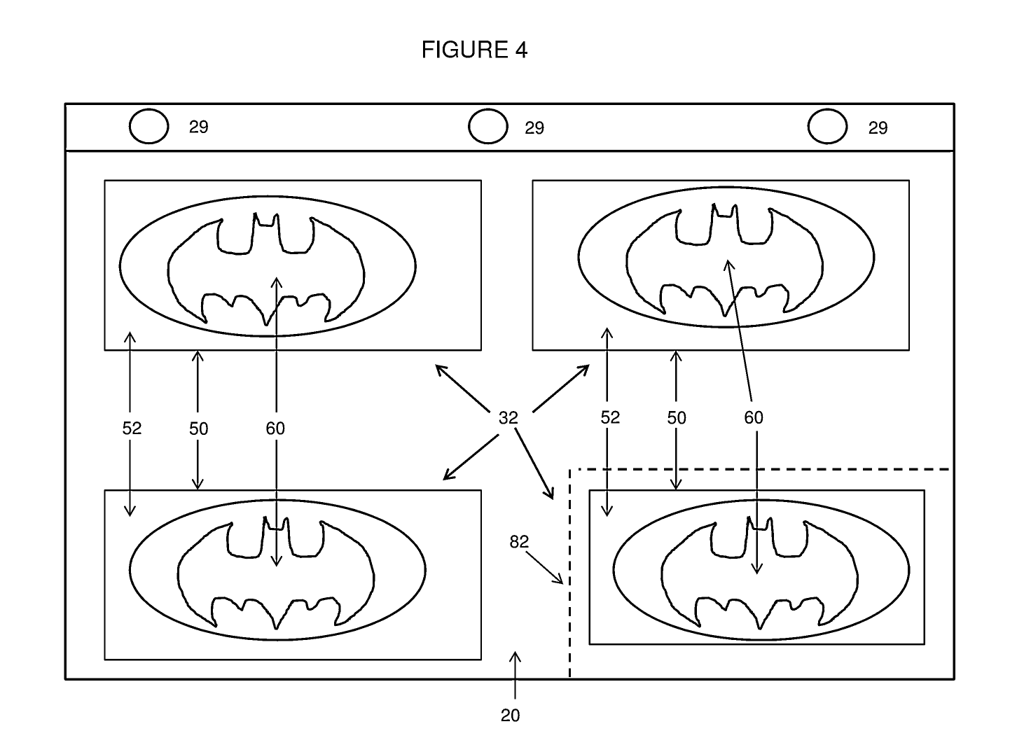

As noted above, FIG. 3 illustrates a sheet 20 of collectible items 32 with the confectionary image items and any intermediate layers removed, leaving the novelty image items 40. FIG. 4 illustrates a sheet 20 of collectible items 32 with the confectionary image item 50 still intact on top of the underlying novelty image items.

As shown in FIG. 3 and in FIG. 4, each collectible item 32 may be surrounded by a perforated perimeter 82 frangibly separable from the overall sheet 20 so as to allow easy removal of an individual collectible item 32 from the sheet 20. Removal of a collectible item 32 means removal of the sticker, the intermediate layer and the gum together with any edible paper as one unit. In this way, the removed item may be traded, and may be placed into and stored in a binder of sheets of a different person without damaging the sticker or the gum. Alternatively, each collectible item may be formed individually instead of as part of a sheet containing multiple items separated by perforations. When formed individually, the same confectionary image item, intermediate layer, and novelty image item may be joined together by the same process as for a sheet of collectible items.

As shown in FIG. 3, each collectible item 32 may have a surrounding attachment layer 80 that may be made of paper or plastic and that may have a perforated region 82 that may include a punched hole 83. This allows an individual collectible item 32 to be removed from a sheet and inserted, for example, into a ring of a three ring binder so as to store, collect and trade individual collectible items 32 without having to store them on sheets. Therefore, a consumer may also have a second option of instead placing the individual collectible items 32 on the sheet by removing the peelable back layer of the sticker 40 and placing the entire collectible item 32 (for example a collectible item 32 that another consumer removed from his or her sheet 20 traded or gave the first consumer as a whole unit) on sheet 20 as part of a collection of such items on sheet 20. Sheet 20 may have punch holes 29 for insertion into the three ring binder. In this way, sheets 20 of collectible items 32, including the novelty image items and confectionary image items, may be collected and saved on a book of sheets 20. The collectible item can later be removed from sheet 20 by removing the sticker 40 together with the layers above it (intermediate layer 70, gum 50 and optionally edible icing paper) as a unit from the sheet 20. It can then be traded and placed by someone else in a sheet of their binder, or it may be placed by that other person through a ring of their binder using the attachment layer 80 (before or after the perforated area has been removed).

According to some embodiments, a character image on a sticker of a collectible item may match an edible image on the top of the chewable gum. The images on the stickers and gum form a pattern within the plurality of collectible items on a sheet, which may in turn relate to a secret message on the intermediate layer, gum backing layer, sticker image, or underlying sheet.

According to some embodiment, there may be a multiplicity of sheets that may be held or bound together. Each of the sheets may be similar to or different than other sheets. The sheets may be held affixed to a binder in a variety of ways.

According to some embodiments, such as those shown in FIGS. 3 and 4, each sheet may have aligned holes 29 suitable for insertion into a three-ring binder. Alternatively, the sheets may simply be bound together at common left sides thereof as in a book of sheets. The sheet 20 may contain a multiplicity of collectible items 32 spaced from one another on the top surface, wherein each collectible item 32 includes a novelty image item 40 (shown in FIG. 3) and a confectionary image item 50 (shown in FIG. 4).

For example, purely illustratively, sheet 20 may contain on it three or four rows and three or four columns to produce total numbers of collectible items 32 equaling either nine, twelve or sixteen. As an example, FIGS. 3 and 4 show two rows of two stickers in a row. There can also be more than three or four rows or columns. Furthermore, the collectible items 32 may be arranged in ways other than in vertical and horizontal rows and columns. Accordingly, the collectible items 32 on sheet 20 may form a pattern or design such that even though there may be spaces between the collectible items 32 on the sheet, the overall group of collectible items 32 on the sheet may appear to match the image on the individual stickers.

According to other embodiments, the sheet does not need to be separated into rectangular or square columns. Instead, the perforations may be circular, rectangular, triangular, or any other shape. The confectionary image layer and novelty image item layer may also form any shape.

According to one embodiment, each collectible item may be presented on a sheet that may have three ring holes and may have a fresh seal that may be attachable to the sticker album to create a collection.

In some preferred embodiments, each collectible item of a multiplicity of items may be similar to other collectible items 32 on a sheet 20 in terms of general structure, but may differ in that each one may have different images and each may have different secret messages. In some versions, all items on a sheet are identical to one another in all respects.

Each sheet may be held under fresh seal in that an individual sheet may be enveloped in a transparent soft plastic wrapping, such as cellophane, which may both maintain air tight freshness and protect collectible items on sheet, and may also allow clear visibility of the gum and confectionary image through the wrapper. The transparent plastic wrapping may have a re-sealable fold on a top or side portion. When access to an individual collectible item is desired in order to consume the confectionary item, trade the novelty image item, or both, the plastic wrapping is opened and the entire sheet is removed or so much as is necessary to access the desired collectible item. The sheet minus the removed collectible item 32 may then be re-sealed within the plastic wrapper. Alternatively, separate individual sections of the sheet may be removed at perforation points in order to remove that section of the sheet. The consumer may then access individual collectible items within the removed section. The different sections separated by perforations may contain the same image, or may contain a plurality of different images among the various sections. As shown in FIG. 3, each collectible item 32 may include a sticker 40 as the novelty image item that may have an image 42 on a top surface of the sticker, with the image 42 facing up relative to the sheet 20. An image 42 may be two-dimensional or three-dimensional. In some instances, the image may be of a well-known character, such as those characters that appear in cartoons, movies, television, and the like. Images may be written text, drawings, cartoons, letters, numbers, pictures, or the like. As discussed above, when the novelty image items are stickers, the stickers may be of various types, including scented, scratch-and-sniff, foil, reflective, or hologram stickers.

By way of example, FIGS. 3 and 4 show a situation in which the novelty image item and confectionary image item may include matching images. As mentioned above, FIG. 3 shows four collectible items 32 on a sheet 20 with everything removed from each collectible item 32 except for the stickers 40 and any backing or other materials between the sticker and the sheet 20. FIG. 4 shows four collectible items 32 on sheet 20 with the entire collectible item 32 intact, including the gum 50 and edible image 60 on a top surface 52 of the gum 50 which overlay the stickers. Each sticker in FIG. 3 has a character image 42 of a Batman™ cape, while each gum item 50 in FIG. 4 carries the a matching image of a Batman™ cape as edible image 60. In some embodiments, the matching images may vary slightly sufficient to allow the edible image 60 to be integrated with gum 50. In alternative embodiments, the image on the gum may be different from the image on the sticker. For example the gum may have an image of a character from Batman™, while the underlying sticker may include an image of a Batman™ cape. According to some embodiments, collectible items on a sheet may be arranged such that the images on the gum represent various characters, while the underlying sticker of each collectible item contains a logo related to the characters.

In an alternative embodiment, the collectible item does not need to be presented as multiple collectible items on a single sheet. Individual collectible items may be produced comprising a confectionary image item, intermediate layer, and novelty image item. Each confectionary image item, intermediate layer, and novelty image item may be produced as a single collectible item, in a strip of collectible items, or as a pack of collectible items. At least one collectible item comprising a confectionary image item, intermediate layer, and novelty image item may be included within a trading card pack. A plurality of collectible items with different images relating to a theme may be grouped together and sold in a pack or a strip. For example, a plurality of collectible items containing images of animals on the confectionary image items and novelty image items may be grouped together in a to pack, with an intermediate layer separating the novelty image item of one collectible item from the confectionary image item of the following collectible item. In the examples discussed above, the intermediate layer may comprise a backing paper of the novelty image items, a plastic wrapping, a wax paper sheet, or any other material designed to separate the edible surface of the confectionary image item from the surface of the novelty image item.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A novelty image item and edible confectionary image item assembly, comprising:
at least one novelty image item having a top surface, wherein the novelty image item has an image on a top surface; and
at least one edible confectionary image item having a top surface and having a bottom surface, the top surface including thereon an edible image;
wherein each of the at least one edible confectionary image items is positioned adjacent to a corresponding one of the at least one novelty image items.

2. The assembly of claim 1, further comprising an intermediate layer separating the confectionary image item from the novelty image item.

3. The assembly of claim 2, wherein the intermediate layer forms a backing layer of the confectionary image layer, the intermediate layer being adheringly attached to the top surface of the novelty image item or a perimeter of the top surface of the novelty image item.

4. The assembly of claim 1, wherein the at least one novelty image item includes a plurality of novelty image items, and wherein the at least one confectionary image item includes a plurality of confectionary image items to form a plurality of assemblies.

5. The assembly of claim 4, wherein the plurality of assemblies are joined together to form a sheet.

6. The assembly of claim 5, wherein each assembly within the plurality of assemblies is surrounded by a perforated perimeter frangibly separable from the sheet so as to allow removal of individual items from the sheet.

7. The assembly of claim 1, wherein the confectionary image item is attached to the back of the novelty image item.

8. The assembly of claim 7, wherein the confectionary image item is directly attached to the back of the novelty image item, without an intermediate layer separating the two.

9. The assembly of claim 1, wherein the novelty image item comprises a sticker, temporary tattoo, collectible trading card, band-aid, business card, greeting card, stationary, or invitation.

10. The assembly of claim 1, wherein the confectionary image item comprises a gum layer, a lollipop layer, a gummy candy layer, a hard candy layer, or a fruit roll layer.

11. The assembly of claim 1, wherein the edible image is directly embedded or printed on the top surface of the confectionary image item.

12. The assembly of claim 1, wherein the edible image is formed as a separate edible layer and placed on top of the confectionary image item.

13. The assembly of claim 2, further comprising a message contained on the intermediate layer or novelty image item, wherein the message is hidden by the confectionary image item.

14. The assembly of claim 5, wherein the sheet contains at least one hole for insertion into a binder.

15. A method of forming a collectible item including a novelty image item and an edible confectionary image item, the method comprising:
providing at least one novelty image item having a top surface, wherein the novelty image item has an image on a top surface;
providing at least one edible confectionary image item having a top surface and having a bottom surface, the top surface including thereon an edible image; and
positioning each of the at least one edible confectionary image items adjacent to a corresponding one of the at least one novelty image items.

16. The method of claim 15, further comprising providing an intermediate layer separating the confectionary image item from the novelty image item.

17. The method of claim 16, wherein providing the intermediate layer comprises placing the novelty image item within a protective layer before placement next to a confectionary image item.

18. The method of claim 15, wherein the novelty image item comprises a sticker, temporary tattoo, collectible trading card, band-aid, business card, greeting card, stationary, or invitation.

19. The method of claim 15, wherein the confectionary image item comprises a gum layer, a lollipop layer, a gummy candy layer, a hard candy layer, or a fruit roll layer.

20. The method of claim 15, further comprising forming a plurality of collectible image items on at least one sheet.

21. The method of claim 20, comprising forming a plurality of sheets and grouping the plurality of sheets together.
